(19) United States
(12) Patent Application Publication
(10) Pub. No.: US 2022/0113094 A1
(43) Pub. Date: Apr. 14, 2022

(54) HEAT ACCUMULATOR WITH PRESSURE LOSS REGULATION

(71) Applicant: Siemens Gamesa Renewable Energy GmbH & Co. KG, Hamburg (DE)

(72) Inventors: Niels Pagelsen, Hamburg (DE); Constanze Skoeries, Uetersen (DE); Jennifer Verena Wagner, Hamburg (DE); Viktor Schmunck, Börnsen (DE)

(21) Appl. No.: 17/425,838

(22) PCT Filed: Jan. 29, 2020
(86) PCT No.: PCT/EP2020/052113

§ 371 Date: Jul. 26, 2021

(30) Foreign Application Priority Data
Jan. 30, 2019 (EP) 19154601.9

(51) Int. Cl. F28D 20/00

(52) U.S. Cl. CPC F28D 20/0034

(57) ABSTRACT

Provided is a heat accumulator including a heat exchange chamber having a lower portion and an upper portion and being configured to accommodate therein heat storage elements for storing thermal energy, wherein the heat exchange chamber includes an inlet which is configured to supply a working fluid into the heat exchange chamber. A passively controlled first pressure loss regulating device is arranged within the flow of the working fluid in the heat exchange chamber and configured to pass the working fluid through, wherein the first pressure loss regulating device is configured to form a first flow resistance for a flow of the working fluid in the first pressure loss regulating device being different to a flow resistance for a flow of the working fluid in the heat exchange chamber adjacent and outside the first pressure loss regulating device.

### CROSS-REFERENCE TO RELATED APPLICATIONS

This application claims priority to PCT Application No. PCT/EP2020/052113, having a filing date of Jan. 29, 2020, which is based on EP Application No. 19154601.9, having a filing date of Jan. 30, 2019, the entire contents both of which are hereby incorporated by reference.

### FIELD OF TECHNOLOGY

The following relates to heat accumulator and to a method of operating a heat accumulator.

### BACKGROUND

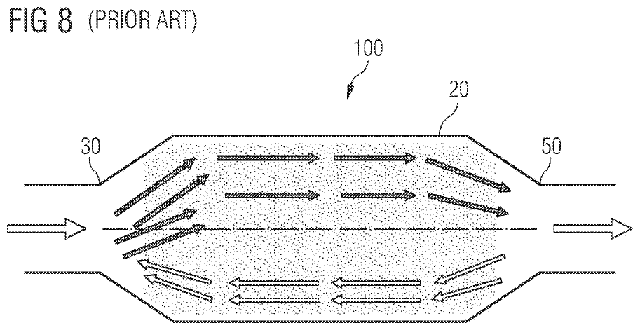

FIG. 8 shows a conventional heat accumulator 100 comprising a heat exchange chamber 20 having a lower portion and an upper portion and being configured to accommodate heat storage elements therein for storing thermal energy. The heat exchange chamber 20 comprises an inlet 30 at the left-hand side of FIG. 8, which is configured to supply a hot working fluid into the heat exchange chamber 20. The hot working fluid is indicated by arrows from the left to the right side in FIG. 8. The heat exchange chamber 20 comprises an outlet 50 for the hot working fluid at the right-hand side of FIG. 8.

The outlet 50 is also configured to supply a cold working fluid into the heat exchange chamber 20. The cold working fluid is indicated by arrows from the right to the left side in FIG. 8. The inlet 30 and the outlet 50 can are structurally be configured as a combined in- and outlet, respectively. That means, the hot working fluid leaves the heat exchange chamber 20 via the outlet 50, and the cold working fluid leaves the heat exchange chamber 20 via the inlet 30.

The heat accumulator 100 is configured to accommodate heat storage elements for storing thermal energy. The heat storage elements can consist of stones, in particular lava stones, ceramic elements, brick elements, granite or basalt. The storage elements are provided as bulk material and have a high thermal storage capacity.

The hot working fluid can be water, hot or relatively cold steam, air, nitrogen or argon, etc. The hot working fluid is cooled by the heat storage elements and then leaves the heat exchange chamber 20 via the outlet 50.

After the charging is completed, the heat exchange chamber 20 may be left in a standstill period of hours or even days until the stored thermal energy is needed and discharged by feeding the cold working fluid to the outlet 50. After having flown through the heat exchange chamber 20 and the heat storage elements, the thus heated working fluid is ejected from the inlet 30 at the left-hand side in FIG. 8.

FIG. 8 depicts a horizontal heat accumulator, in which the fluid is guided between inlet and outlet mainly in horizontal direction. A similar horizontal heat accumulator design is shown in patent publications US 2018/0238633 A1. Different to that heat accumulators can also be arranged in a vertical orientation, in which the fluid is guided between inlet and outlet mainly in vertical direction. Such a system is shown in US 2015/0114591 A1.

In a different design, fluid may not freely flow though the heat exchange chamber but may be guided through piping surrounded by heat storage elements. Such a design is shown in US 2013/0111903 A1.

Experiments have shown that the heat exchange chamber particularly in a horizontal orientation—exhibits areas of different flow resistances due to different temperatures. For example, the hot working fluid (hot air) hardly enters the areas of a relatively high flow resistances, for example in the lower portion. However, it was also found that when the heat exchange chamber is discharged, the cold air hardly passes through the upper portion.

### SUMMARY

An aspect relates to a method of operating a heat accumulator having improved efficiency.

The inventors found out that the pressure loss via the heat accumulator, particularly a horizontally arranged heat accumulator, during charging shall be reduced in the lower portion relative to the upper portion, and during discharging, the pressure loss in the upper portion shall be reduced relative to the lower portion.

This applies particularly for horizontal heat accumulators in which the fluid is guided between inlet and outlet through a heat exchange chamber mainly in horizontal direction.

According to a first aspect of embodiments of the invention, a heat accumulator comprises a heat exchange chamber having a lower portion and an upper portion and being configured to accommodate heat storage elements therein for storing thermal energy, wherein the heat exchange chamber comprises an inlet which is configured to supply a working fluid into the heat exchange chamber. An outlet is configured to discharge the working fluid to the outside of the heat exchange chamber. The heat exchange chamber allows a flow of a fluid portion of the working fluid from the inlet through the lower portion of the heat exchange chamber to the outlet without passing the upper portion of the heat exchange chamber. At least one passively controlled first pressure loss regulating device is arranged in the lower portion of the heat exchange chamber and within the flow of the working fluid in the heat exchange chamber and configured to pass the working fluid through, wherein the first pressure loss regulating device is configured to form a first flow resistance for a flow of the working fluid in the first pressure loss regulating device being different to a flow resistance for a flow of the working fluid in the heat exchange chamber adjacent and outside the first pressure loss regulating device.

“Passively controlled” means that actuation happens just by pressure differences surrounding the pressure loss regulating device without an active control system controlling the device.

“Fluid portion” means that this first part of the fluid and another second part of the fluid may act different. That means that a part of the fluid may exclusively be guided through the lower portion of the heat exchange chamber, without diverting to the upper portion. Nevertheless another part of the fluid may intentionally be guided from the inlet through the upper portion of the chamber, e.g. to heat also the upper portion of the heat exchange chamber.

The first pressure loss regulating device can loosely be arranged within heat storage elements, or the first pressure loss regulating device can be mounted by mechanical links to the heat exchange chamber.

The first flow resistance in the first pressure loss regulating device can be made either higher or lower than the flow resistance for the flow of the working fluid in the heat exchange chamber adjacent and outside the first pressure loss regulating device. By varying geometrical parameters such as a diameter and/or a length of a flow channel within the first pressure loss regulating device, the first flow resistance can be adapted according to the demands. For example, by using a relatively large diameter, the first flow resistance can be made higher than the flow resistance for the flow of the working fluid in the heat exchange chamber adjacent and outside the first pressure loss regulating device. In contrast, by using a relatively small diameter, the first flow resistance can be made smaller than the flow resistance for the flow of the working fluid in the heat exchange chamber adjacent and outside the first pressure loss regulating device.

Advantageously, the efficiency of the heat accumulator is remarkably increased since larger areas of the heat exchange chamber can be used up to the complete storage bubble and not just a few areas as was previously the case. In addition, it is possible that the still warm working fluid does not only flow through the relatively cold areas during discharging, but also through the warmer areas and thus does not lose as much heat.

The heat exchange chamber comprises an outlet which is configured to discharge the working fluid to the outside of the heat exchange chamber. In an embodiment, the heat exchange chamber has a first distance d1 between the inlet and the outlet, and the first pressure loss regulating device is arranged in a second distance d2 from the inlet, either with d2>0.25 d1, d2>0.33 d1, or d2>0.5 d1.

The first pressure loss regulating device is arranged in the lower portion of the heat exchange chamber. Other pressure loss regulating device may also be arranged in the upper portion of the heat exchange chamber.

The heat exchange chamber comprises an outlet which is configured to discharge the working fluid to the outside of the heat exchange chamber and to supply another working fluid into the heat exchange chamber.

The heat exchange chamber may comprise a passively controlled second pressure loss regulating device which may be arranged within the flow of the other working fluid in the heat exchange chamber and configured to pass the other working fluid through, wherein the second pressure loss regulating device may be configured to form a second flow resistance for a flow of the other working fluid in the second pressure loss regulating device being different to a flow resistance for a flow of the other working fluid in the heat exchange chamber adjacent and outside the second pressure loss regulating device. The second pressure loss regulating device may be arranged in the upper portion of the heat exchange chamber.

In an embodiment, at least one of the first pressure loss regulating device and the second pressure loss regulating device may be configured to pass through the working fluid in one direction and to block a flow of the working fluid in a direction opposite to the one direction.

In an embodiment, the first pressure loss regulating device and/or the second pressure loss regulating device may comprise a tube portion, a ball arranged in the tube portion to be axially movable between a first stop portion and a second stop portion of the tube portion. The tube portion has at least one input opening being arranged at a side of the first stop portion, which is opposed to the second stop portion, and at least one circumferential output opening which is arranged in a circumferential wall of the tube portion between the first stop portion and the second stop portion.

This embodiment of the pressure loss regulating device is a tube which is opened by a one-sided closing mechanism for a flow in one direction, and it is closed to a flow in the opposite direction.

During charging, the flow resistance is reduced in the first pressure loss regulating device so that the flow flows through the tube portion according to the principle of minimum work, and during discharging, the flow resistance is increased. This is enabled by the ball that can move freely in the pipe. This ball is moved away from the charging side by the flow during charging, and the working fluid (air) can flow through the output opening(s) such as bores or grooves from the tube portion into the heat accumulator.

The diameter and length of the tube portion and the diameter of the ball can be adapted to achieve different flow resistances. Advantageously, by varying the length of the tube portion, the hot flow can be distributed over the entire heat accumulator during charging. Another major advantage is that the pressure loss regulating device, which is formed by a tube portion, acts in both directions and does not require two different components for charging and discharging. Therefore, the costs can remarkably be reduced.

In an embodiment, the first stop portion and/or the second stop portion may be provided with a seal to provide for a sealing between the tube portion and the ball. A seal on both sides of the tube portion can ensure that the ball cannot leave the tube portion and that the flow cannot pass through gaps to the right-hand side and the left-hand side of the ball. For example during discharging, the ball of the first pressure loss regulating device moves in the opposite direction, where are no openings so that the working fluid (air) cannot continue to flow through the tube portion.

In an embodiment, the tube portion may be divided in a first part and a second part, the first part comprises the first stop portion and the second part comprises the second stop portion. The first part and the second part can be identically formed in order to save manufacturing costs.

According to a second aspect of embodiments of the invention, the invention is directed to a pressure loss regulating device—as explained before—that is provided for the heat accumulator as discussed.

According to a third aspect of embodiments of the invention, a method of operating a heat accumulator is provided, wherein the heat accumulator comprises a heat exchange chamber having a lower portion and an upper portion and being configured to accommodate heat storage elements therein for storing thermal energy, wherein the heat exchange chamber comprises an inlet which is configured to supply a working fluid into the heat exchange chamber. The heat exchange chamber further comprises an outlet which is configured to discharge the working fluid to the outside of the heat exchange chamber, wherein the heat exchange chamber allows a flow of a fluid portion of the working fluid from the inlet through the lower portion of the heat exchange chamber to the outlet without passing the upper portion of the heat exchange chamber. The method comprises a step of arranging at least one passively controlled pressure loss regulating device in the lower portion of the heat exchange chamber (2) and within the flow of the working fluid in the heat exchange chamber, the pressure loss regulating device being configured to pass the working fluid through, wherein the pressure loss regulating device is configured to form a first flow resistance for a flow of the working fluid in the pressure loss regulating device different to a flow resistance for a flow of the working fluid in the heat exchange chamber adjacent and outside the pressure loss regulating device.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### BRIEF DESCRIPTION

Some of the embodiments will be described in detail, with reference to the following figures, wherein like designations denote like members, wherein:

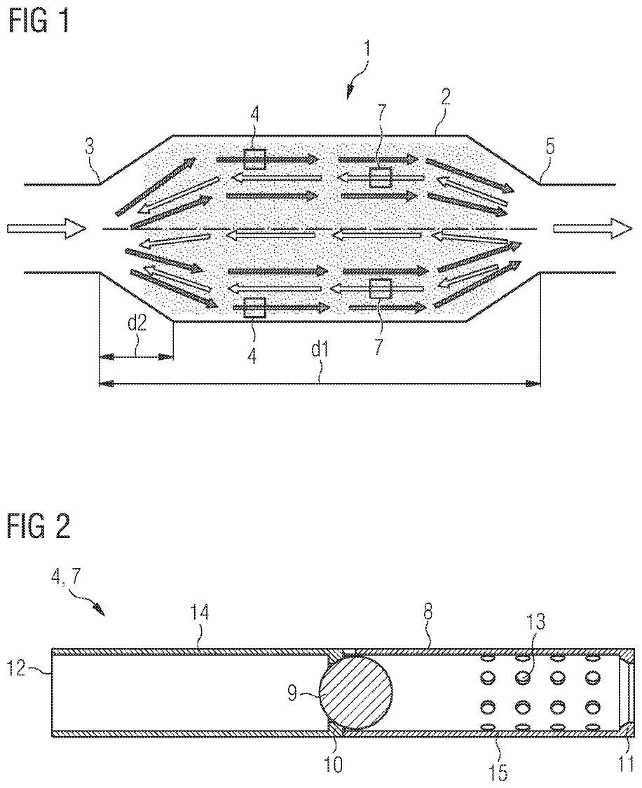

FIG. 1 shows a flow diagram of a heat accumulator according to an embodiment of the present invention;

FIG. 2 shows a pressure loss regulating device according to an embodiment of the present invention;

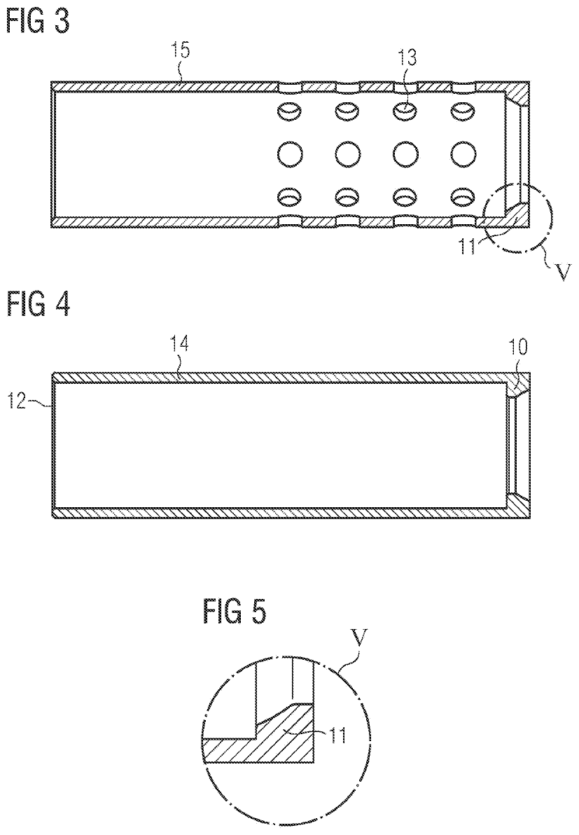

FIG. 3 shows a second part of the pressure loss regulating device according to the embodiment of the present invention;

FIG. 4 shows a first part of the pressure loss regulating device according to the embodiment of the present invention;

FIG. 5 shows a detail of the first part of the pressure loss regulating device according to the embodiment of the present invention in FIG. 4;

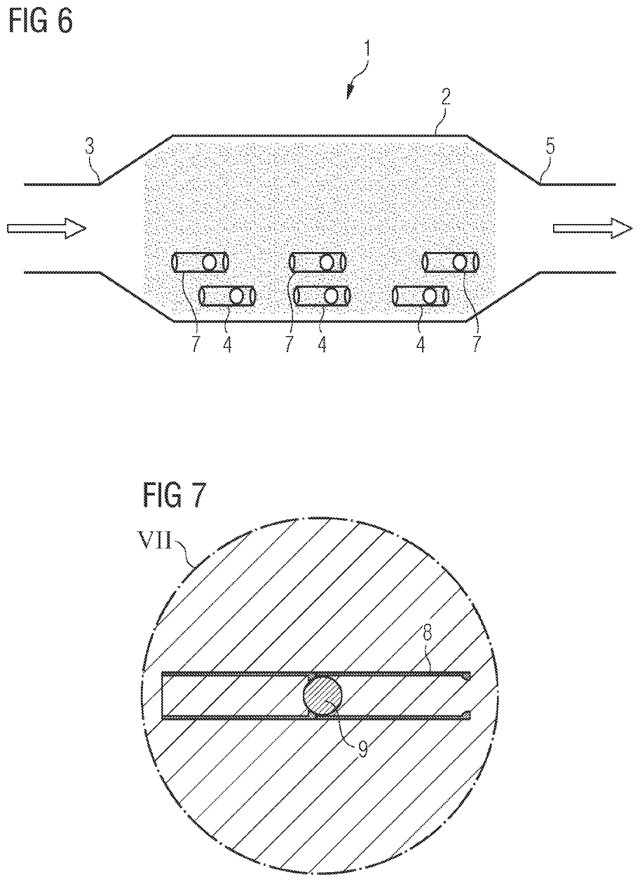

FIG. 6 shows a schematic view of the heat accumulator according to the embodiment of the present invention;

FIG. 7 shows a detail of the heat accumulator in FIG. 6; and

FIG. 8 shows a flow diagram of a conventional heat accumulator.

### DETAILED DESCRIPTION

FIG. 1 shows a flow diagram of a heat accumulator 1 according to an embodiment of the present invention. The heat accumulator 1 comprises a heat exchange chamber 2 having a lower portion and an upper portion. The terms “lower portion” and “upper portion” refer to the orientation of the heat accumulator 1, which is shown as a horizontally arranged heat accumulator, in the intended use.

The heat accumulator 1 is configured to accommodate heat storage elements for storing thermal energy. The heat storage elements can consist of stones, in particular lava stones, ceramic elements, brick elements, ansit, granite or basalt. The storage elements are provided as bulk material and have a high thermal storage capacity.

The heat exchange chamber 2 further comprises an inlet 3 (which can also be a combined in- and outlet) which is configured to supply a hot working fluid into the heat exchange chamber 2 and a plurality of first pressure loss regulating devices 4. The first pressure loss regulating devices 4 are arranged within the flow of the working fluid in the heat exchange chamber 2 and configured to pass the working fluid through. The first pressure loss regulating devices 4 are configured to form a first flow resistance for a flow of the working fluid in the first pressure loss regulating devices 4 being different to a flow resistance for a flow of the working fluid in the heat exchange chamber 2 adjacent and outside the first pressure loss regulating devices 4. The working fluid can be water, hot or relatively cold steam, air, nitrogen or argon, etc. The thus cooled working fluid leaves the heat exchange chamber 2 via an outlet 5 (or a combined in- and outlet). The flow of the hot working fluid is indicated by arrows from the left side to the right side in FIG. 1.

After the charging is completed, the heat exchange chamber 2 may be left in a standstill period of hours or even days until the stored thermal energy is needed and discharged by feeding another, cold working fluid to the outlet 5 (which is here used as an inlet for the cold working fluid). After having flown through the heat exchange chamber 2 and the heat storage elements, the thus heated working fluid is ejected from the inlet 3 (which is here used as an outlet for the cold working fluid). The flow of the cold working fluid is indicated by arrows from the right side to the left side in FIG. 1.

The heat exchange chamber 2 has a first distance d1 between the inlet 3 and the outlet 5, wherein at least one of the first pressure loss regulating devices 4 is arranged in a second distance d2 from the inlet 3 and wherein the relation d2>0.25 d1 holds. Other first pressure loss regulating devices 4 can be arranged such that the relations d2>0.33 d1 and d2>0.5 d1, respectively, hold.

At least one of the first pressure loss regulating devices 4 is arranged in the lower portion of the heat exchange chamber 2. At least one second pressure loss regulating device 7 is arranged within the flow of the other, cold working fluid in the heat exchange chamber 2 and configured to pass the cold working fluid through, wherein the second pressure loss regulating device 7 is configured to form a second flow resistance for a flow of the cold working fluid in the second pressure loss regulating device 7 being different to a flow resistance for a flow of the cold working fluid in the heat exchange chamber 2 adjacent and outside the second pressure loss regulating device 7. The second pressure loss regulating device 7 is arranged in the upper portion of the heat exchange chamber 2.

The first and second pressure loss regulating devices 4, 7 are configured to pass through the working fluids in one direction and to block a flow of the working fluids in a direction opposite to the one direction.

FIG. 2 shows a pressure loss regulating device 4, 7 according to an embodiment of the present invention; FIG. 3 shows a second part of the pressure loss regulating device 4, 7 according to the embodiment of the present invention; FIG. 4 shows a shows a first part of the pressure loss regulating device 4, 7 according to the embodiment of the present invention; and FIG. 5 shows a detail of the first part of the pressure loss regulating device 4, 7 according to the embodiment of the present invention in FIG. 4.

FIG. 6 shows a schematic view of the heat accumulator 1 according to the embodiment of the present invention, and FIG. 7 shows a detail of the heat accumulator 1 in FIG. 6.

The pressure loss regulating device 4, 7 comprises a tube portion 8 and a ball 9 arranged in the tube portion 8 to be axially movable between a first stop portion 10 and a second stop portion 11 of the tube portion 8. The tube portion 8 has at least one input opening 12 being arranged at a side of the first stop portion 10, which is opposed to the second stop portion 11, and a plurality of circumferential output openings 13 which are arranged in a circumferential wall of the tube portion 8 between the first stop portion 10 and the second stop portion 11.

The pressure loss regulating device 4, 7 are arranged in horizontal direction, as shown in FIG. 6.

The first stop portion 10 and the second stop portion 11 are provided with a corresponding seal to provide for a sealing between the tube portion 8 and the ball 9.

The tube portion 8 is divided in a first part 14 and a second part 15, the first part 14 comprises the first stop portion 10 and the second part 15 comprises the second stop portion 11.

The operation of the pressure loss regulating device 4, 7, which is embodied by the tube portion, is as follows: For example during charging, the hot working fluid enters the tube portion 8 of the first pressure loss regulating device 4 through the input opening 12 and moves the ball 9 from the first stop portion 10 to the second stop portion 11. The working fluid is then forced to leave the tube portion 8 through the output openings 13 to enter the heat exchange chamber 2.

During discharging, the cold working fluid enters the tube portion 8 of the pressure loss regulating device 4 through the output openings 13 and moves the ball 9 back from the second stop portion 11 to the first stop portion 10. The working fluid cannot pass further through the first stop portion 10 due to the sealing. In other words, the working fluid cannot pass from the second part 15 of the tube portion 8 to the first part 14 of the tube portion 8.

Embodiments of the present invention can be modified in that the output openings 13 are positioned along a helix so that a uniform flow through the heat exchange chamber 2 can be achieved. In another modification, at least one output opening 13 can be arranged in a shape of a slit.

As a further modification, instead of the ball locking mechanism as described above, other locking mechanisms can also be used. For example, it is possible to use a type of one-way valve or check valve. For this purpose, an air-impermeable foil can be placed over a perforated sheet and fixed so that the air flows in one direction only against the foil, but cannot pass the edges, and in the other direction, the foil can slightly be lifted from the sheet and can flow through the pipe.

Another modification would be a flap that can be opened in one direction by the flow via a hinge. Opening in the other direction is not possible because the flap is pressed against a sheet metal and thus seals the pipe. However, a square pipe cross-section would be an advantage here.

The pressure loss regulating devices 4, 7 are passively controlled. In a modification, a subset of the pressure loss regulating devices can actively be controlled. The here described mode is a passive mode. For example, an active pressure loss regulating device may be actuated by a motor or a pneumatic control.

It is possible to provide the inlet 3 with a diffusor and to provide the outlet 5 with a nozzle.

Generally, and to summarize, the basic configuration of a particularly horizontal - heat accumulator comprises: a heat exchange chamber having a lower portion and an upper portion and being configured to accommodate heat storage elements therein for storing thermal energy, wherein the heat exchange chamber comprises an inlet which is configured to supply a working fluid into the heat exchange chamber; and a pressure loss regulating device which is arranged within the flow of the working fluid in the heat exchange chamber and configured to pass the working fluid through or by, wherein the pressure loss regulating device is configured to form a flow resistance for a of the working fluid in the pressure loss regulating device being different to a flow resistance for a flow of the working fluid in the heat exchange chamber adjacent and outside the first pressure loss regulating device.

Particularly this may apply to a heat exchanger chamber with piled up loose solid material bulk material—as heat storage elements with gaps between the solid material, so that the working fluid is guided through these gaps, thereby transferring heat from the working fluid to the storage elements in a loading cycle (with a working fluid temperature above present temperature of the storage elements) and transferring heat from the storage elements to the working fluid in a unloading cycle (with a present temperature of the storage elements above a working fluid temperature).

In such a system convection may take place resulting in a non-even temperature distribution. The inventive use of the pressure loss regulating device(s) helps to avoid natural convection.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A heat accumulator comprising:
a heat exchange chamber comprising a lower portion and an upper portion and being configured to accommodate heat storage elements therein for storing thermal energy, wherein the heat exchange chamber comprises an inlet which is configured to supply a working fluid into the heat exchange chamber and an outlet which is configured to discharge the working fluid to an outside of the heat exchange chamber, wherein the heat exchange chamber allows a flow of a fluid portion of the working fluid from the inlet through the lower portion of the heat exchange chamber to the outlet without passing the upper portion of the heat exchange chamber; and
at least one passively controlled first pressure loss regulating device which is arranged in the lower portion of the heat exchange chamber and within a flow of the working fluid in the heat exchange chamber and configured to pass the working fluid through or by, wherein the at least one passively controlled first pressure loss regulating device is configured to form a first flow resistance for a flow of the working fluid in the at least one passively controlled first pressure loss regulating device being different to a flow resistance for a flow of the working fluid in the heat exchange chamber adjacent and outside the at least one passively controlled first pressure loss regulating device.

2. The heat accumulator according to claim 1, wherein the heat exchange chamber has a first distance between the inlet and the outlet; and
the at least one passively controlled first pressure loss regulating device is configured to release the working fluid into the heat exchange chamber in a second distance from the inlet, either with the second distance >0.25 the first distance, the second distance>0.33 the first distance, or the second distance>0.5 the first distance.

3. The heat accumulator according to claim 1, wherein the outlet is further configured to supply another working fluid into the heat exchange chamber, and the heat exchange chamber comprises at least one passively controlled second pressure loss regulating device which is arranged within the flow of the other working fluid in the heat exchange chamber and configured to pass the other working fluid through, wherein the at least one passively controlled second pressure loss regulating device is configured to form a second flow resistance for a flow of the other working fluid in the at ono passively controlled second pressure loss regulating device being different to a flow resistance for a flow of the other working fluid in the heat exchange chamber adjacent and outside the at least one passively controlled second pressure loss regulating device; and
The at least one passively controlled second pressure loss regulating device is arranged in the upper portion of the heat exchange chamber.

4. The heat accumulator according to claim 1, wherein at least one of the at least one passively controlled first pressure loss regulating device and the one at least one passively controlled second pressure loss regulating device is configured to pass through the working fluid in one direction and to block a flow of the working fluid in a direction opposite to the one direction.

5. The heat accumulator according to claim 1, wherein the at least one passively controlled first pressure loss regulating device and/or the at least one passively controlled second pressure loss regulating device comprises:
a tube portion; and
a ball arranged in the tube portion to be axially movable between a first stop portion and a second stop portion of the tube portion; wherein the tube portion has at least one input opening being arranged at a side of the first stop portion, which is opposed to the second stop portion, and at least one circumferential output opening which is arranged in a circumferential wall of the tube portion between the first stop portion and the second stop portion.

6. The heat accumulator according to claim 5, wherein the first stop portion and/or the second stop portion is provided with a seal to provide for a sealing between the tube portion and the ball.

7. The heat accumulator according to claim 5, wherein the tube portion is divided in a first part and a second part, the first part comprises the first stop portion and the second part comprises the second stop portion.

8. A passively controlled pressure loss regulating device configured to be used in the heat accumulator according to claim 1, wherein the passively controlled pressure loss regulating device 4 is configured, when placed in the heat accumulator, to pass working fluid through or by, and wherein the passively pressure loss regulating device is further configured to form a first flow resistance for a flow of the working fluid in the passively controlled pressure loss regulating device being different to a flow resistance for a flow of the working fluid in the heat exchange chamber adjacent and outside the passively controlled pressure loss regulating device.

9. A method of operating a heat accumulator, the heat accumulator comprising a heat exchange chamber comprising a lower portion and an upper portion and being configured to accommodate heat storage elements therein for storing thermal energy, wherein the heat exchange chamber comprises an inlet which is configured to supply a working fluid into the heat exchange chamber, and an outlet which is configured to discharge the working fluid to an outside of the heat exchange chamber, wherein the heat exchange chamber allows a flow of a fluid portion of the working fluid from the inlet through the lower portion of the heat exchange chamber to the outlet without passing the upper portion of the heat exchange chamber; wherein the method comprises:
arranging at least one passively controlled pressure loss regulating device in the lower portion of the heat exchange chamber and within the flow of the working fluid in the heat exchange chamber, the at least one passively controlled pressure loss regulating device being configured to pass the working fluid through, wherein the at least one passively controlled pressure loss regulating device is configured to form a first flow resistance for a flow of the working fluid in the at least one passively controlled pressure loss regulating device different to a flow resistance for a flow of the working fluid in the heat exchange chamber adjacent and outside the at least one possible controlled pressure loss regulating device.
